(19) United States
(12) Patent Application Publication
(10) Pub. No.: US 2021/0011246 A1
(43) Pub. Date: Jan. 14, 2021

(54) LENS WITH SHIELDING STRUCTURE AND LENS MODULE

(71) Applicant: Newmax Technology Co., Ltd., Taichung City (TW)

(72) Inventors: Kuo-Fu Fan, Taichung City (TW); Hung-Ta Chen, Taichung City (TW); Tsung-Chi Tsai, Taichung City (TW)

(21) Appl. No.: 16/507,923

(22) Filed: Jul. 10, 2019

(51) Int. Cl. G02B 7/02; G02B 13/18

(52) U.S. Cl. CPC G02B 7/021; G02B 13/18

(57) ABSTRACT

A lens with shielding structure includes a main body. The main body defines an axial direction. The main body includes an optical portion and a shielding portion. The optical portion is located at a center of the main body. The shielding portion is annular to surround the optical portion. The shielding portion includes a micro structure and a shielding layer. The micro structure includes a plurality of recesses formed on the main body. The shielding layer is coated on the micro structure to fill the recesses up.

### BACKGROUND OF THE INVENTION

### Field of the Invention

The present invention relates to a lens with shielding structure and a lens module.

### Description of the Prior Art

A conventional lens module includes a lens mount and a plurality of lenses coaxially arranged in the lens mount. Light is focused and diverged for imaging. To avoid imaging from being interfered by stray light, shielding plate sandwiched between non-optical portions of lenses is usually used, as shown in patent TW I628484. The stray light is thereby absorbed, and light is focused better to improve imaging.

However, a lens module includes at least three to four, even ten lenses. If the shielding plate is set between any two adjacent lenses, the thickness of the lens module is increased. Thus, it is difficult to make the electronic device having the lens module thinner. If the lens module is protruded above the electronic device, the lens may damage easily.

### SUMMARY OF THE INVENTION

The main object of the present invention is to provide a lens with shielding structure and a lens module having better shielding performance and smaller thickness.

To achieve the above and other objects, the lens with shielding structure of the present invention includes a main body. The main body defines an axial direction. The main body includes an optical portion and a shielding portion. The optical portion is located at a center of the main body. The shielding portion is annular to surround the optical portion. The shielding portion includes a micro structure and a shielding layer. The micro structure includes a plurality of recesses formed on the main body. The shielding layer is coated on the micro structure to fill the recesses up.

To achieve the above and other objects, a lens module of the present invention includes a lens mount and a plurality of lenses. At least one of the lenses is the lens with shielding structure mentioned above. The lenses are arranged in the lens mount coaxially.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a lens module of the present invention;

FIG. 2 is a profile showing a lens module of the present invention;

FIG. 3 is a partial enlargement of FIG. 2;

FIG. 3A is a partial enlargement of FIG. 3;

FIG. 4 is a profile showing a lens with shielding structure of the present invention;

FIG. 5 is a partial enlargement of FIG. 4;

FIG. 6 is a partial profile showing a second embodiment of a lens with shielding structure of the present invention;

FIG. 7 is a partial profile showing a third embodiment of a lens with shielding structure of the present invention;

FIG. 8 is a profile showing a fourth embodiment of a lens with shielding structure of the present invention;

FIG. 9 is a partial enlargement of FIG. 8;

FIG. 10 is an illustration showing a fifth embodiment of a lens with shielding structure of the present invention;

FIG. 11 is a partial profile of FIG. 10;

FIG. 12 is a profile showing a second embodiment of a lens module of the present invention;

FIG. 13 is a profile showing a third embodiment of a lens module of the present invention.

### DETAILED DESCRIPTION OF THE PREFERRED EMBODIMENTS

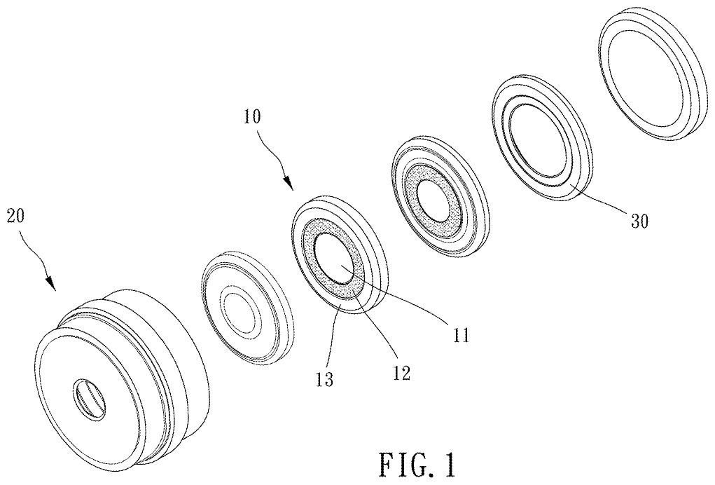

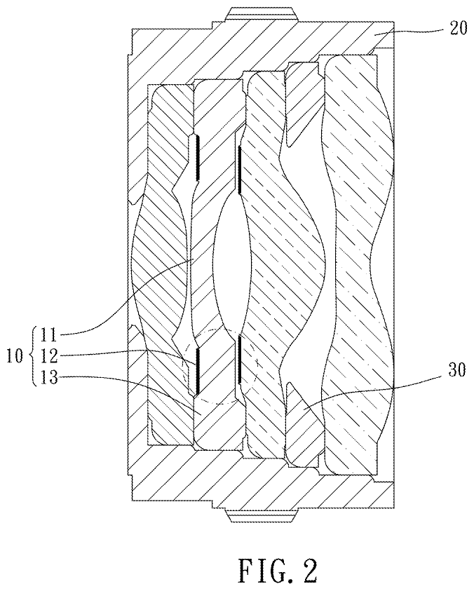

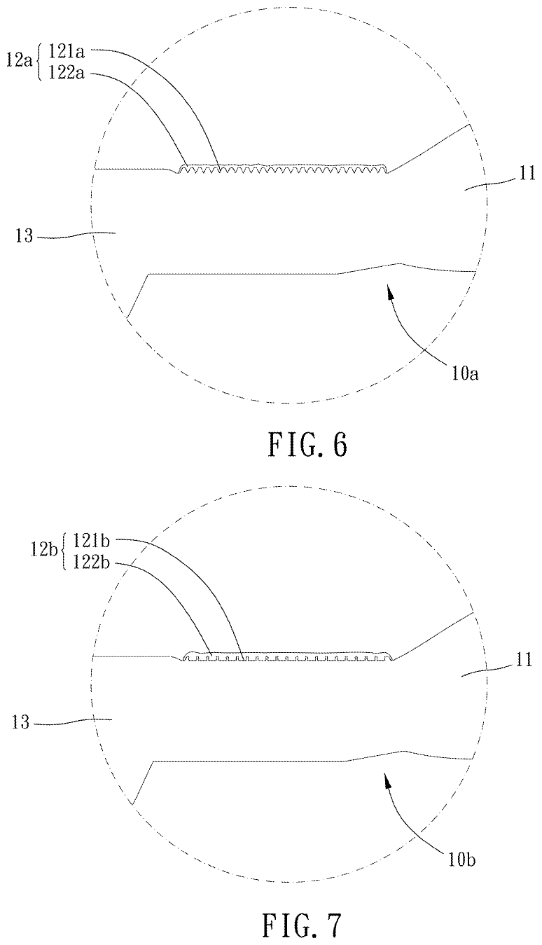

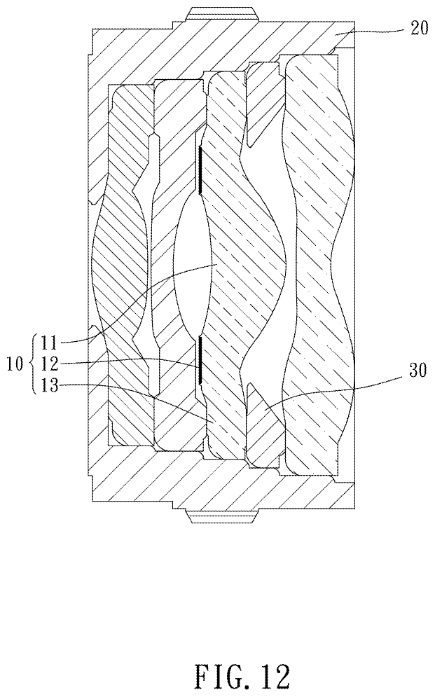

Please refer to FIG. 1 to FIG. 13, the lens with shielding structure of the present invention includes a main body 10,10a,10b,10c. The main body 10,10a,10b,10c defines an axial direction. The main body 10,10a,10b,10c includes an optical portion 11 and a shielding portion 12,12a,12b,12c,12d. The optical portion 11 is located at a center of the main body 10,10a,10b,10c. The shielding portion 12,12a,12b,12c,12d is annular to surround the optical portion 11. The shielding portion 12,12a,12b,12c,12d includes a micro structure 121,121a,121b,121a,121d and a shielding layer 122,122a,122b,122c,122d. The micro structure 121,121a,121b,121a,121d includes a plurality of recesses formed on the main body 10,10a,10b,10c. The shielding layer 122,122a,122b,122c,122d is coated on the micro structure 121,121a,121b,121a, 121d to fill the recesses up. For example, a black ink or UV gel is coated on the micro structure and is solidified by UV curing or oven. Preferably, the main body 10,10a,10b,10c further includes a positioning portion. 13 surrounding the shielding portion 12,12a,12b,12c,12d for engaging with other lenses and the lens mount 20. Besides, the shielding portions 12,12a,12b,12c,12d can be arranged on only one side of the main body 10,10a,10b,10c or on both sides of the main body 10,10a,10b,10c.

The present invention further provides a lens module including a lens mount 20 and a plurality of lenses. At least one of the lenses is the lens with shielding structure mentioned above. The lenses are coaxially arranged in the lens mount 20. In the present embodiment, the lenses include a plurality of lenses with shielding structure mentioned above and also at least one normal lens. To prevent the optical portions of the lenses from contacting each other, a spacer 30 is arranged between the adjacent lenses.

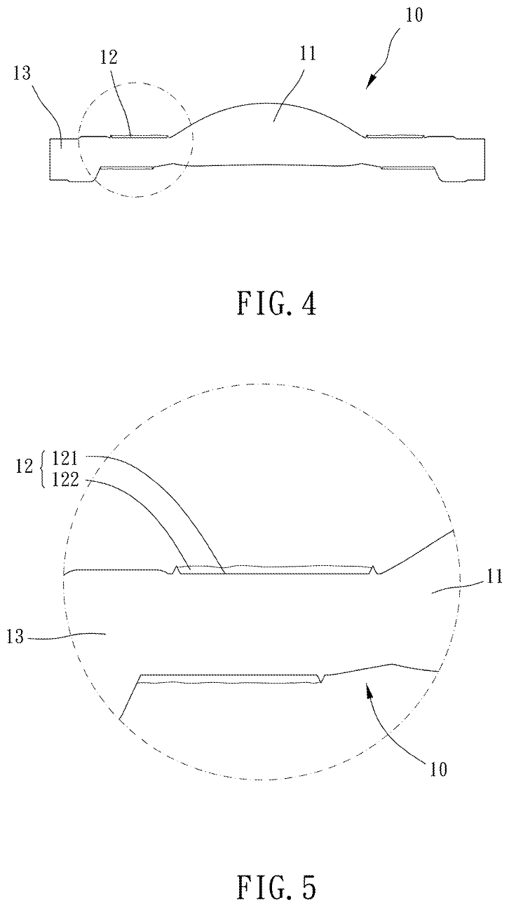

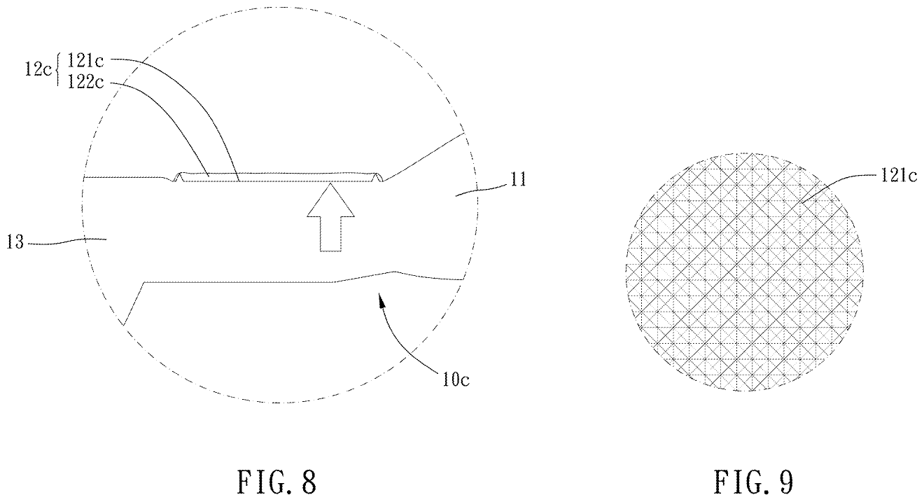

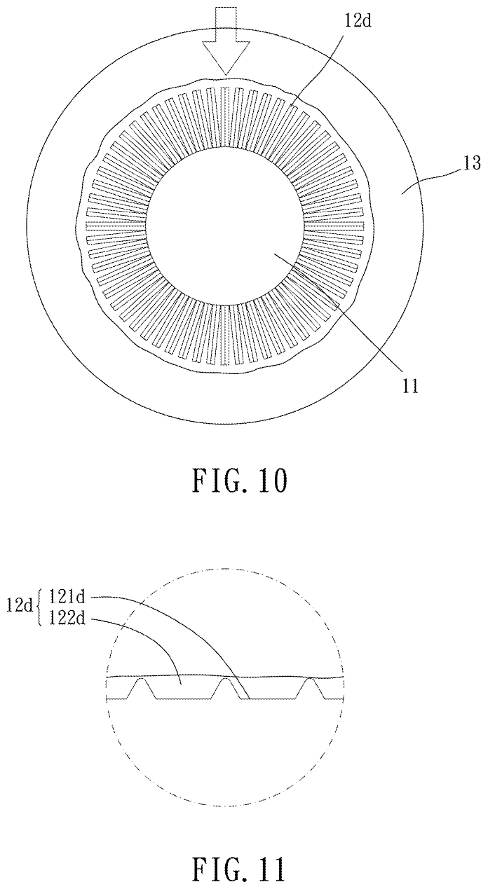

In view of the micro structure 121,121a,121b,121c,121d, for instance, the recesses can be a plurality of laser engraved annular grooves extending around the axial direction and arranged spacedly. Each of the annular grooves has a cross-section which is reversed triangle, rectangle, trapezoid, semi-circle, or other shape, as shown in FIG. 4 to FIG. 7. In other possible embodiment, the recesses are distributed evenly and are pyramid-shaped as shown in FIG. 8 and FIG. 9, or a plurality of elongated grooves arranged radially as shown in FIG. 10 and FIG. 11. Besides, the recesses can be formed by sandblasting.

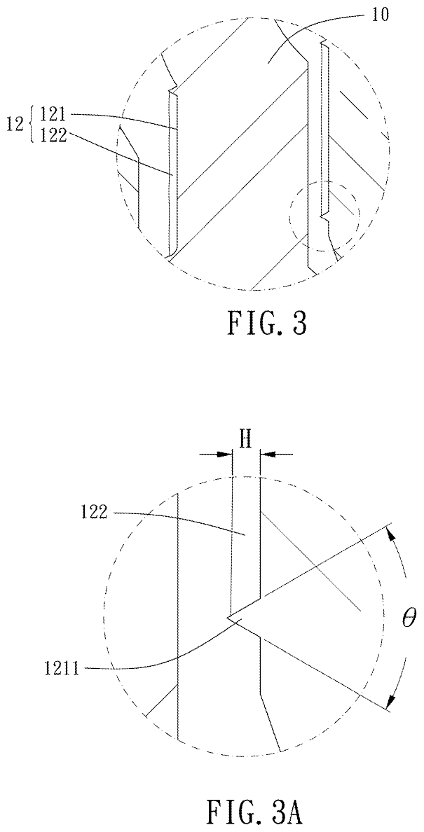

Specifically, as shown in FIG. 3A, the micro structure has a protruded blocking portion 1211 at each of two ends thereof along a radial direction. The recess of the micro structure is defined between the two blocking portions 1211. The shielding layer 122 fills up a space between the two blocking portions 1211. A height H of the shielding layer 122 is ranged between 15-25 micrometers. Each of the blocking portion 1211 has a cross-section which is triangle. An outer corner has an angle θ ranged between 40-135 degrees.

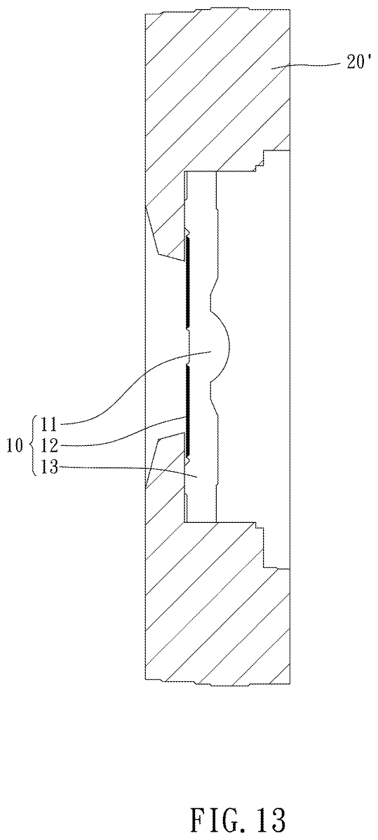

In conclusion, the lens with shielding structure of the present invention can reduce stray light, make optical path concentrated, and prevent from interference. In addition, shielding plate is not necessary so that the thickness of the lens module can be reduced. For example, as shown in FIG. 13, one lens with shielding structure is necessary so that the lens can be arranged in thinner lens mount 20′ to reduce distance of optical axis. Thus, the lens can be used in thinner electronic device. Also, the lens can replace aperture plate.

What is claimed is:

1. A lens with shielding structure, including a main body, the main body defining an axial direction, the main body including an optical portion and a shielding portion, the optical portion being located at a center of the main body, the shielding portion being annular to surround the optical portion, the shielding portion including a micro structure and a shielding layer, the micro structure including a plurality of recesses formed on the main body, the shielding layer being coated on the micro structure to fill the recesses up.

2. The lens with shielding structure of claim 1, wherein the recesses are annular grooves which extend around the axial direction and are arranged spacedly.

3. The lens with shielding structure of claim 2, wherein each of the annular grooves has a cross-section along a radial direction which is reversed triangle.

4. The lens with shielding structure of claim 2, wherein each of the annular grooves has a cross-section along a radial direction which is rectangle.

5. The lens with shielding structure of claim 2, wherein each of the annular grooves has a cross-section along a radial direction which is trapezoid.

6. The lens with shielding structure of claim 1, wherein the recesses are distributed evenly, each of the recesses is pyramid-shaped.

7. The lens with shielding structure of claim 1, wherein the recesses are elongated grooves arranged radially.

8. The lens with shielding structure of claim 1, wherein the main body further including a positioning portion located at outside of the shielding portion along a radial direction.

9. The lens with shielding structure of claim 1, wherein the micro structure has a protruded blocking portion at each of two ends thereof along a radial direction, the recess of the micro structure is defined between the two blocking portions, the shielding layer fills up a space between the two blocking portions, a height of the shielding layer is ranged between 15-25 micrometers, each of the blocking portion has a cross-section which is triangle, an outer corner has an angle ranged between 40-135 degrees.

10. A lens module, including a lens mount and a plurality of lenses, at least one of the lenses being the lens with shielding structure of claim 1, the lenses being arranged in the lens mount coaxially.

11. The lens module of claim 10, wherein the main body includes a positioning portion surrounding the shielding portion for engaging with others of the lenses and the lens mount.
